(19) United States
(12) Patent Application Publication
(10) Pub. No.: US 2008/0250193 A1
(43) Pub. Date: Oct. 9, 2008

(54) Method to transmit important emergency personal and medical information via portable storage media

(76) Inventor: Daniel Lee Smith, Sharpsburg, GA (US)

Correspondence Address: DANIEL LEE SMITH, 450 BARRINGTON FARMS PARKWAY, SHARPSBURG, GA, 30277, US

(21) Appl. No.: 11/810,413

(22) Filed: Jun. 5, 2007

Related U.S. Application Data
(60) Provisional application No. 60/922,531, filed on Apr. 9, 2007.

(51) Int. Cl. G06F 13/28

(52) U.S. Cl. 711/103; 711/E12.002

(57) ABSTRACT

This invention presents a way to carry concise, important personal and medical information in a very portable format using information storage media, in a convenient carrying form for universal use by emergency medical or police personnel to assist the person carrying the device.

### CROSS-REFERENCE TO RELATED APPLICATIONS

### Not Applicable

### BACKGROUND

1. Field of Invention

This invention relates to portable media storage devices in general, and to USB flash drives in particular.

2. Description of Prior Art

For years now, the primary medical information device for use in an emergency situation has been the medic alert bracelet. This is a bracelet that a patient would wear, alerting any potential emergency personnel that something about the patient deserves special attention—it basically directs the emergency worker to call a certain number to get information about that particular patient. There are a number of problems with this. One, it requires the emergency person, who might be busy trying to save the patient's life, to stop everything, even CPR, apparently, and place a phone call, hoping someone answers right away, and there is no busy signal. This all takes time—time can cost lives. Two, you are hoping the people on the other end of the line have the latest information, that the information is completely up to date. This information might only contain special allergies, for example. It does not have all the information an emergency person would want, such as past medical history, list of current medications, current doctors, emergency contacts, living will presence, etc. There is a better way.

For a few years now, portable storage media has been available to store digital information, primarily in items such as camcorders, digital cameras, and the like. Primarily, the storage media has been used to store photos to replace regular camera film.

There are a number of forms available: compact flash; secure digital card, mini-secure digital card, digital video tapes, USB flash drives, mini-DVD; mini-CDROM and others. To date, again, these are used primarily for the storage of photos, music, movies, and very rarely text.

There are any number of patents available which describe the construction of these portable memory storage devices. Some of these are: U.S. Pat. Nos. 7,074,052; 6,890,188; 7,052,287; 7,112,875, 7,177,159; 7,036,742; 6,663,007; 6,739,515; 7,185,146; 7,185,146

Currently, medical information is stored primarily in paper form, but some information is available on computers. Unfortunately, there are a multitude of various software programs that are being used in hospitals and physician offices across the country, as well as overseas, with no way to integrate them, or read each other's data. As a result, at present, there is no real way to transmit concise, targeted, important personal or medical information in an emergency setting. For example:

Suppose a man is in a terrible car wreck in a strange town. He is unconscious; bleeding behind the steering wheel; the jaws of life are going to be needed to get him out. There is no way to get to his hips to look for a wallet and important information. He is bleeding copiously. Lives can be measured in minutes. The EMT or paramedic just shake their heads. There is no way to get the information they need in time to possibly help this person, such as current medical condition, allergies, doctor information, emergency contact information, living will information, blood type, insurance, etc. The present invention would solve this.

Another scenario: An elderly woman has Alzheimers, or some other kind of dementia or altered mental status; she is also diabetic. Her daughter gives her the morning insulin shot, and turns her back. Before breakfast is served, the elderly woman walks out the door and down the street. A couple of miles later, a police officer finds the woman. She is confused from the Alzheimers; she cannot tell the officer where she lives; what her daughter's last name is, since it would be her married name; she is getting more confused by the minute due to a drastically lowering blood sugar. The present invention would solve this.

Yet another scenario: A youngster in 6^{th} grade suddenly has an allergic attack. There is no school nurse. The principal cannot locate the mother, or get her to answer the phone. No one knows what medicine she is on; who her doctor is, and so forth. All they can do is take her to the ER and let them sort it out. There is a better way.

This invention is about storing important personal and medical information in a secure digital memory card, USB flash drive, or similar, and then that card containing the important information could be carried in a key chain, necklace, bracelet, lanyard, or similar, so that emergency personnel can obtain important information if the patient is unable or unwilling to convey such information. Such information might include: name, address, emergency contacts, doctor's information, current medical diagnoses, current medications, blood type, insurance name and numbers, presence of living will, and many other kinds of information. If this information were on a keyring, in the event of a traumatic accident, the EMT would only have to grab the key ring, take out the digital storage card, or USB flash drive, and insert it into any computer or PDA which accepts SD cards or has USB ports (which every computer has). The file would be in TXT format, or DOC format, such as is used in universal software like Microsoft Word, and is easily read by any computer. This would possible save a lot of time, and in emergency settings, time is life. This would give the medical personnel very important medical information that might help them treat the patient more effectively and perhaps save his or her life, or at least minimize the damage to the patient. Particularly in the case mentioned of an Alzheimers' patient, a portable file in a very small device would ensure the patient is returned to his or her home in the shortest possible time. The above mentioned scenarios would include all of us; everyone should carry this device in case of emergency. The information in the device can be updated endlessly as needed such as a change of doctors, change in medicine, or new diagnoses; and hard copies of the information can easily be printed when the device is inserted into a host computer by pressing the print button, if desired by the emergency facility for inclusion in the patient's chart. Information may be composed in a host computer, then “dragged and dropped” into the flash device, when it is inserted into a USB port. Or, when the device is inserted, it can be opened by the host computer, and information input directly into it, or any information already there can be edited as desired by a word processor on the host computer. Text, as mentioned, should be in .DOC or .TXT format; graphic information should be entered and stored as .JPEG, .BMP, or GIF information, as these are universal computer formats for pictures, which, again, can be read by virtually any computer in the world.

In U.S. Pat. No. 6,140,936, Armstrong depicts a reusable electronic storage device comprised of a memory card, and protective container with attachment points for jewelry. The memory card contains medical or veterinary information about the bearer. In his invention his storage device contains extensive files, directories and other information about the wearer. It has pictures of the wearer, as well as thumbprints, fingerprints, even tissue, bodily fluid, or hair sample from which a DNA sample could be extracted. It has a retina scan of the wearer, is encrypted, has password protection, and is in a container which is shock resistant, pressure resistant, moisture resistant, dust resistant, corrosion resistant, EMI/EMP resistant, heat resistant, and resistant to radiation. It is also attached to a “personal timekeeping device”. The devices claimed to include are: Smart Media cards, Compact Flash cards, and Intel® Miniature cards.

This device is totally unsuited for emergency personal or medical use. One, it has entirely too much information; one would have to sift through the vast amount of information to find the crucial items. This takes time—time taken can take lives. Another very important limitation is the fact that it is encrypted, and has password protection. Many times in emergencies, the person is disoriented, or even unconscious, which means he or she cannot give the code or password to the emergency personnel allowing them access to the files, which means, in essence, the files are worthless. Emergency devices MUST NOT be encrypted—they must be openly available to anyone who needs to read the information. There is certainly a trade-off between utility and privacy, but in this case, utility must rule. If you keep your information private, you might just take that information to the grave. Care must be taken not to include that all important number in the device: the social security number. If you do not include that number, any included information would basically be only useful to medical and emergency personnel. The information must be concise, only perhaps 2 pages long, and give all the needed information in that limited space, so that an emergency person can quickly scan and obtain the needed information in just a few moments.

The Armstrong invention also does not address the kind of software that would need to be in the device—the software needs to be universal, and not proprietary; that is, software that is only in use in a few offices. Many doctor's offices carry their own patient software. This is fine for reading their own files, but if one of their patients is traveling to another state, or even in the same city, unless whoever rescues them has the exact same software, their computer is only going to read gibberish. Again, the files would be completely worthless. If your invention does not have universal software, it is useless. The failure of Armstrong to address this issue renders his invention unworkable on a national scale. People also travel overseas. If they have the current invention, unencrypted, in a .TXT or .DOC format, such as Microsoft Word, almost any computer in the world would be able to read it, since Microsoft products are global.

In his invention he also includes a protective container which is impervious, it would seem, to everything known to man. He does not, however, give examples of what this marvelous material might be. In the current invention, such a marvelous, and predictably expensive, container is not needed.

Further, Armstrong does not claim USB flash devices, but does claim to attach it to some kind of personal timekeeping device—which is not necessary, and is useless clutter in the present invention. A USB flash device, as is in the present invention, can be used in every single computer—all computers have USB ports; the other devices which are listed in the Armstrong invention unfortunately need a card or media reader attached to the computer in order to use them. Most computers do not have these and require a separate piece of equipment be attached to the computer in order to read these. Most computers in the business world no not have these media readers. Again, this would severely limit the usefulness of the Armstrong invention. Thus, everything considered, the Armstrong invention simply would not work as an emergency medical device, not only in the United States, but abroad.

U.S. Pat. No. 3,958,690 is a medical information and medication package with folding card and printed instructions in an envelope. This invention is easily damaged and hard to carry and it is not intended to be worn as a jewelry item, nor as a keychain. The size of this would make it difficult to carry all the information needed, such as could be carried in the present invention. Also, it cannot be updated without issuing a new one, unlike the present invention, rendering it probably obsolete at any given time, since medications, etc., can change fairly rapidly.

U.S. Pat. No. 5,197,763, a biomedical information card and method of making, refers to a kit so that individuals can create their own emergency medical data card which is “slightly smaller than a credit card” and is “attached to a blank rigid plastic card”. U.S. Pat. Nos. 5,171,039 and 4,745,268 refer to “wallet-size” cards. U.S. Pat. No. 4,816,653 is a portable data carrier for “individual medical and/or banking records” which “looks and feels much like an ordinary credit card.” Again, these are easily damaged and are not intended to be worn as a keychain, nor can it carry all the information that emergency personnel would require, or desire, such as the current invention. Again, these cannot be updated with new or changing information unless a brand new item is issued. This would entail additional substantial cost and time delay.

U.S. Pat. No. 4,491,725 is a medical insurance verification and processing system which reads a “medical information card (MEDICARD)” to “determine a patient's background medical and insurance information.” This system is specifically for insurance processing and specific reference is made to transmitting information to a “central brokerage computer”. The card does not carry the kind of information which is needed in an emergency setting, and would not be nearly as useful, nor complete, as the current invention. A card could also not be updated without issuing an entirely new card, unlike the present invention.

U.S. Pat. No. 5,590,038 is a “universal electronic transaction card” which is capable of serving as a number of different cards including “credit cards, bank cards, identification cards, employee cards, medical cards, and the like.” The user can press graphical images on the card to select the card type. The specific use as a medical card is not elaborated, nor its use in emergency conditions, nor its being worn as a keychain. This obviously is not suitable as a device to convey important emergency information. Additionally, all computers would have to have the same kind of software to read what information is contained, and the patent does not address this. Without the same kind of software, few computers could get information from the card; it would appear as just symbols and numbers, thus be worthless. Credit-card-size emergency medical cards may be used to store medical data as printed text and images on plastic and paper media and the like, but they are limited in the amount of printed area, are easily damaged, and such cards are not easily distinguishable from other cards carried by the bearer. Credit-card and wallet-size devices are not easily worn as keychains or in necklaces and the like.

U.S. Pat. No. 4,197,665 is an identification locket with “an information bearing card “in a substantially reduced form” and which has a magnifying lens. While it can be worn as jewelry, magnifying devices are needed and the amount of information stored on the card is still very limited. Further, this invention is not necessarily for emergency situations. This device simply could not carry the amount of information needed for emergency purposes. Additionally, unlike the present invention, the information could never be updated without issuing an entirely new card. The present invention can be updated simply by inserting the flash drive into an USB port, pulling it up, changing the information as desired, and then removing the device. Very simple.

Emergency medical tags and pet tags indicating critical medical conditions and personal data may be worn, typically on a necklace, collar, bracelet, or wristband, but only a small amount of data may be displayed on the surface of such tags.

Images of medical documents may be reduced and stored on microfilm. U.S. Pat. No. 4,259,391 is an identification card with transparent laminate using microfilm. Microfilm cards may be carried as is or attached to emergency medical cards, but such film is easily damaged. In addition, reading microfilm images generally requires an optical magnifying device. Not only would it require an optical device, the optical device would have to be designed to read that particular kind of microfilm. Every hospital, clinic and physicians office in the country would have to have a compatible device to read this. This is very unlikely to happen, and thus, the device itself will probably never be produced.

The aforementioned medical cards, tags, and microfilm cannot be easily reused. When the relevant data changes, a new card, tag, or microfilm image is needed; at substantial cost, as a new one will be required frequently, and then there will be a time delay between issuance of a new card. It might be that the information would change before a new card is even issued, requiring yet another new card.

U.S. Pat. No. 5,325,294 is a medical privacy system which uses an identification card with a photograph or holographic image and a “visually perceptible” “first identification number” which is associated with a “confidential second identification number” on a computer database. This system associates two numbers, but does not use data encryption nor file system password protections. Further it specifies that the actual data is available via a “telephonic readout” implying that the data is not on or in the card itself. If you need to go elsewhere to obtain data, time delay is inevitable, and some emergency situations would cost a person his life if you have unnecessary time delay. The present invention has information immediately available, and is thus superior to the above mentioned patent.

U.S. Pat. No. 4,795,898 is for a “personal memory card the size of a standard plastic credit card.” This device receives power from an external signal. Data may be stored on electronic memory cards, but is limited, and being a credit card shape, means it could be easily mistaken for a plain credit card and not even used, or recognized by emergency personnel. Again, data must be stored in a form that is recognizable by all computers, and that is not discussed in this invention-a shortcoming as compared to the present invention.

U.S. Pat. No. 3,970,996 is an apparatus for collecting medical data which basically collects data from an ID card and prints it. There is no provision for use in emergency conditions. Further, neither the size of the card nor for the amounts and types of data stored on the card are specified. There is no provision for use on common personal computers. This is obviously not suitable for emergency use.

U.S. Pat. No. 5,675,744 is for a medical service workstation and includes an “optical card carried by the patient” and read through an ISDN interface. Similarly, U.S. Pat. No. 5,708,851 is a system for managing medical information using a “hybrid card” with an “optical stripe.” U.S. Pat. No. 5,622,429 utilizes a memory card for transferring data between operating room equipment. These cards are not intended for emergency conditions, for storage of necessary medical information nor for personal use, nor for wear as a keychain, etc; they also suffer from the same limitations as the other multiple card-like patents already discussed.

Small electronic storage devices have been invented for storing electronic images taken with digital cameras. Commonly called “flash memory”, these devices come in four standard types: PCMCIA (Personal Computer Memory Card International Association),CompactFlash.™. (CF.™.) (by SanDisk Corporation), Miniature Card (by Intel.®. Corp.), and SmartMedia.™. (also known as SSFDC) (by Toshiba).

The largest of these is PCMCIA, which is credit-card size. All PCMCIA cards have a standard length and width (85.6 mm.times.54.0 mm, or 3.3 inches.times.2.13 inches), but have different thicknesses: Type I is 3.3 mm, Type II is 5.0 mm, and Type III is 10.5 mm thick. All three types use the same type of 68-pin connector. The PCMCIA standard provides for 3.3 Volt and 5.0 Volt operation. The Type IV specification is believed to be under development and is expected to be 18.0 mm thick.

PCMCIA card reader devices are a common feature on some, but not all, laptop computers, and card reader devices are available as an option on some desktop computers and palmtop computers. Media card readers typically can “read” up to 9 different types of media storage cards, all of various sizes. Printers nowadays, more likely have these readers, since they are commonly used to store photos from camcorders and digital cameras and the like. Optional card readers can be purchased if desired, to hook up to standard desktop computers, but are not universally used, especially in health care settings. Thus, if the emergency information containing device uses one of these formats, it is likely that the hospital or clinic to which the patient is taken cannot read it, as they do not have a card reader. Conversely, if the emergency device which contains the patient information is a USB flash drive, there is no question as to whether or not the hospital's computers can read the data, providing the data has been stored in the previously mentioned universal formats of .DOC or .TXT.

Though they are credit-card sized, PCMCIA cards are still too large to be worn comfortably on a necklace or wristband, particularly if they are in protective containers. CompactFlash.™., SmartMedia.™., and Miniature Card are considerably smaller than PCMCIA devices, and are small enough to be worn comfortably; however they lack attachment points. CompactFlash.™. cards have approximate dimensions of 45 mm.times.36 mm.times.3.3 mm (5346 cubic mm), SmartMedia.™. have approximate dimensions of 45 mm.times.37 mm.times.0.76 mm (1265.4 cubic mm), and Intel.®. Miniature Card cards have approximate dimensions of 38 mm.times.33 mm.times.3.5 mm (4389 cubic mm).

Flat surfaces of such cards can be used as attachment points, but attaching directly to the card can damage it or affect its ability to be inserted into a card reader device. U.S. Pat. No. 5,161,826 is a “composite medical information and identity card” which is “permanently heat sealed”. Such heating is likely to damage an electronic device.

In addition, card slots to read these devices are not generally provided on personal computers, as it would be expensive to provide all three types plus PCMCIA. An additional card reader, as mentioned above, would have to be purchased at substantial cost, and be available at every computer used in an emergency setting. This is currently not the case. Again, in contrast, ALL computers currently have USB ports.

Via adapters, CompactFlash.™., SmartMedia.™., and Intel.®. Miniature Card may be used in PCMCIA card slots. All types can store electronic files compatible with personal computer operating systems. Some cards are ATA (AT Attachment, or Advanced Technology Attachment) compliant and so can be used directly with some computer operating systems. Linear (or “non-ATA”) cards require special device drivers called Flash File System (FFS) or File Translation Layer (FTL) software. Because these drivers have different versions which are not always compatible with different systems, data cannot always be transferred from one device to another.

U.S. Pat. No. 5,499,293 is for data compression/decompression and makes reference to “medical information storage and retrieval” and a “SmartCard based system.” The purpose of this invention was to make data fit within the limited memory of a variety of devices, and the abstract makes specific reference to “this card based system . . . from a credit-card sized instrument.” Credit card sized cards may fit nicely into a wallet or purse, but are too large to be worn conveniently as jewelry items. Also, being a card shaped item, it suffers from the same multiple limitations already discussed on the very many previous patents on card-shaped devices.

U.S. Pat. No. 5,291,399 is a portable personal database as for a hospital environment which uses memory cards. The size of these cards could be quite large and are not necessarily carried by the person to whom the card's data pertains. Further, this system is specifically for “a hospital environment”, not emergency conditions, to be carried by individuals. Also, the data base would probably be proprietary, meaning few other facilities would be able to get information out of it, unless they also used the very same system, which is unlikely. Thus, this device would be practically worthless as an emergency data device.

In U.S. Pat. No. 6,747,561, Reeves, discloses a bodily worn device for digital storage and retrieval of medical records and personal identification. Again, Reeves includes too much information to be of use in an emergency situation. Also, he includes encrypted software, and user password. This would prove to be a critical failure in emergency situations, probably preventing emergency personnel from accessing the information, and rendering the unit worthless. He also wants the information to be retrieved via a “non-contact” method utilizing some kind of “wand” that would be apparently waved over the device and be able to receive the information via an electronic eye. This will require some kind of power source, and power sources can, and do, fail, which would render the device useless. Also, devices of this kind would not be inexpensive; costs which are not necessary in the present invention.

Again, unless the patient is conscious, and lucid, any information transmitted to the wand would be worthless, since it would be encrypted and need to have a password. Again, the kind of software that would be used is not discussed, but it would have to be universal, and virtually in every computer in the country to decipher the information. A further significant and possibly terminal limitation is that it needs to use some kind of wand to get the information. Unless every hospital, ambulance, and emergency crew get the same kind of unspecified “wand”, no one can use the information. Again, this device is unworkable from an emergency, or practical point of view.

In U.S. Pat. No. 7,043,754, Arnouse discloses a method for secure personal identification, information processing, and precise point of location and timing. A universal lightweight, easily carried memory identification card records information and controls access to this information. The memory card includes a file system of electronic files on the card, which are automatically detected and recognized by selected authorized readers. The file system is organized so that stored electronic files appear in separate and distinct encrypted compartments in the card, so that only authorized preselected readers have access to particular compartments. Biometric identifying information is imprinted in the card, so that no data can be transferred unless there is a biometric match between a reader and a person assigned to the card and who possesses the card. The separate compartments of the memory card may include a compartment containing medical, administrative or financial information relating to the assigned user of the card, wherein the information is accessed only by a preselected memory card reader having the unique pin code assigned to the compartment having the medical information. The memory identification card can also have a single chip Global Positioning System (GPS) to identify where the card is being used.

Interesting, but again, absolutely useless in an emergency situation. Too complex to get important information quickly; too complex software; no mention as to what computers would be able to even read this software; biometric information must be used to even access the card—what if that is not available in an emergency situation? Separate compartments for separate information—this is all useless clutter an emergency person must wade through to get to the import information. Again, that is time that might cost the patient's life. The device would also need a battery to power the GPS device—which would not be needed anyway—emergency personnel know the person they are trying to save is right under them—they do not need the latitude and longitude of the patient-he is right there. What happens if the battery is dead? Would the device work at all? The more complex the device, the more than can break down. This device will probably never make it to the commercial market because of these important limitations.

In the European Patent EP1736926, Liamis Dimothenis and Sarris Nikolaos disclose: “The Electronic Health Book consists of a full operating system that covers the entire system of health, Public and private, having as a center the citizen (holder) and as knots: the Doctor, the Hospital, the Diagnostic center, the drugstore and finally the insurance institution. It uses as storage means an electronic means of large capacity usb or cd or any other large capacity means. It is characterized from the fact that it has the capability to store a large volume of medical information regarding its holder in a form of electronic text, (through special programs), but also medical depictions (radiographs—ultrasound—magnetic etc) all these in fact constitute the full medical history record of the holder, updated by all doctors or hospitals or diagnostic centers, which he visits from time to time. It does not offend personal data because the citizen has it in his full possession, it is encoded, and the doctor's identity when during the visit he submits it to him, it is certified through the system via processes which ensure absolute security for personal data. There is no central medical database from which sensitive medical data of any citizen could transpire. Capability is provided for communication to be conducted by a doctor, hospital, diagnostic center and drugstore with the insurance institution, which covers the holder, through the internet by the use of special programs, so the charges of the medical actions are transferred electronically and the doctors, hospitals, drugstores are compensated for immediately following a full and immediate automated audit. The doctor can after he receive the EHB from the holder to read the entire medical history record of the holder (it is covered by medical secrecy) and to add new examinations, opinions, and prescriptions, leave, as well as financial data regarding medical actions, in electronic form. The pharmacist cannot read medical information with the exception only of the doctor's prescription and to execute it electronically, simply by pressing the specific program option.”

Yet again, this is entirely too complex and has much too much information to be useful in an emergency situation. The emergency person would first have to have the correct kind of software to decipher the information, would have to have the code to get past the encryption, and then would have to wade through hundreds of pages of information, charts, pictures, etc., to try to find the information he needs; all the while his patient might be dying. This is actually an extensive electronic book, as well as an operating system. While it utilizes an USB flash drive, the flash drive is used in a totally different manner, as a total health management operating system, and electronic book, not as an emergency device. An operating system this complex and inclusive would be very difficult to learn effectively and quickly. All possible personnel would have to be specially trained to even use this software. Again, the software would have to be universal, every computer in the country would have to have this specialty software installed on it to even use it. This is very unlikely, and because of these limitations, would probably not be realized commercially or to the public, and be totally unworkable for emergency purposes, or even every day purposes. It also has a built in GPS unit, which would require a power source, which can run down, rendering the device useless. Overall, much too complex a system needing too many interlocking, working, parts forming a whole system; one weak point will crash the entire thing. And, of course, much too unwieldy and complex for a rapid response, emergency device.

While all the above mentioned patents are interesting, none achieves what the present invention achieves: reliable, quick, effective, concise, universal transmission of the most important personal and medical information in an emergency setting.

### DESCRIPTION OF INVENTION

The preferred embodiment of the present invention is to use an USB flash drive of small capacity; it would be attached to a key chain; would be red; have the words, “Emergency Medical File” on the surface; would have information in either .DOC or .TXT format, such as is found and used by Microsoft Word, which is found on virtually almost every computer in the world, and would have as much of the following information as possible: name, address, and phone number of the patient; name and phone numbers of emergency contacts; name and phone number of doctors; current diagnoses; current medications; allergies; concise past medical history; blood type; date of birth; insurance; presence or absence of living will; organ donor. All of this information would easily fit on 2 typed pages. It would be easily and rapidly scanned, and easily used by anyone. The USB device would not need more than 64 MB of storage capacity; even this would far exceed the amount of data that would probably be stored on the device. Limiting the capacity ensures the price of the device is as inexpensive as possible, making it more likely that people will carry the device. The elderly, in particular, having a limited budget, need to have such a device be inexpensive. The USB device also does not need a power source; another item that costs is eliminated because the device is powered by the computer it is plugged into. Thus, one does not need to be concerned about the power source running down, rendering it useless, or replacing batteries, etc.

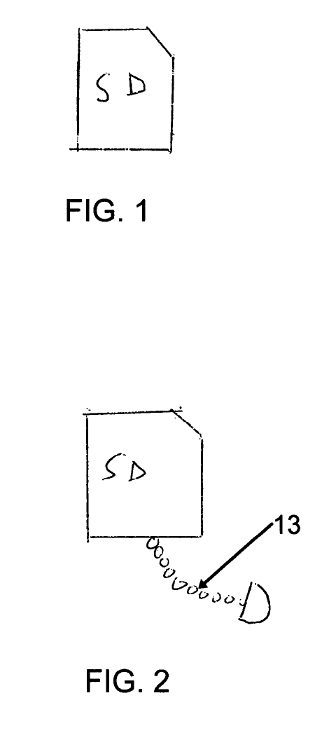

FIG. 1 shows a secure digital card storage medium.

FIG. 2 shows the card attached to a keychain. It might be enclosed in a container, and the container attached to a keychain.

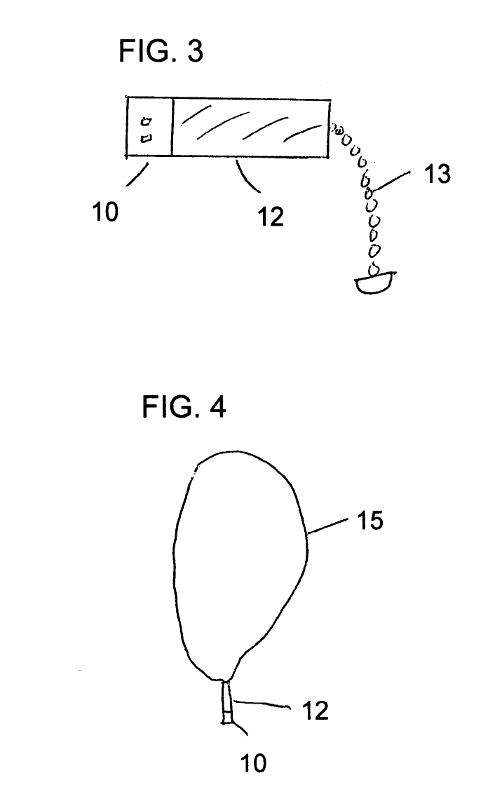

FIG. 3 shows an USB flash drive; #10 is the connecting end; 12 is the body of the flash device. #13 is the keychain. It could also be hung from a lanyard or necklace.

The body of the USB flash drive can actually be many shapes, colors, and sizes. The end can retract, flip, or just be covered with a cap. However, the end that is inserted, regardless of how it fits into the body, still only mates one way into a USB port. Once inserted into a port, it can have information dragged and dropped into it, directly entered into it, or have the information which is in it already, edited, deleted, or otherwise altered, or supplemented. It is freely editable using a word processor in a computer, such as Microsoft Word.

FIG. 4 shows an USB flash device attached to a necklace or lanyard. #15 is the necklace or lanyard, and #10 is the attachment end of the USB flash device which will be inserted into an USB port. #12 is the body of the flash device.

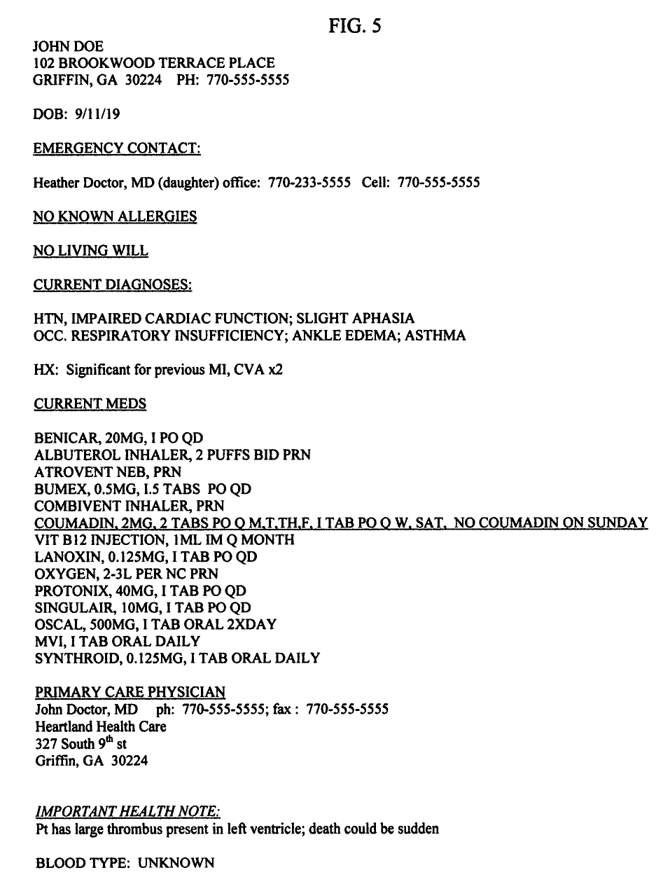

FIG. 5 shows typical, concise, useful information that could be included on the device.

### REFERENCE NUMERALS IN DRAWINGS

10 Connecting end of USB flash device
12 Body of USB flash device
13 Keychain
15 Necklace or Lanyard

### Operation

A simple questionnaire would be filled out by the patient; this information would be entered into a form, or done as free form text, on the word processor on a computer; the connecting end (#10) of the USB flash drive would be plugged into the USB port of that computer; then the completed form or text file could be “dragged and dropped” from the computer into the USB flash drive. Alternatively, a form could be pre-loaded into the USB flash drive, the flash drive plugged into the USB port of a computer, and then use the computer to access the flash drive, and enter the desired information directly into the flash drive. This is a very simple device and is easily used and maintained. A hallmark of the device is its ease of use. It is likewise, just as easily edited. If there is a change in information, the USB flash drive is plugged into the USB port of a computer, the computer is used to access the flash drive, or “pull it up”, then any information can be directly edited on the flash drive, using a word processor, since all information is entered and edited using universal software, such as Microsoft Word, or any program that can edit .DOC or .TXT files. The device is then handed back to the patient to be carried on his or her person. The device will ideally be red, with a prominent label stating “Emergency Medical File”, or similar.

It is critically important that this information is NOT ENCRYPTED. It must not have any kind of password access. These would slow down, and possible prevent, the access of emergency personnel and thus render the device totally useless. Every medical person in the entire United States, and possibly the world, must be able to easily access, and use the information on the device by simply plugging it into a computer. The SSN should not be included to help prevent identity theft, and since it is absent, the information mentioned previously would be basically only of use to medical and emergency personnel. Just as there is in medicine, there is a risk-benefit ratio to having the device easily accessible; yes, some unauthorized person might be able to use some of the information, but the risk of that is minimal compared to the great benefit obtained in an emergency situation when lives are at stake.

An alternative embodiment would have the flash drive attached to a necklace or lanyard.

Another embodiment would have a secure digital card with the already mentioned information, attached to a key chain.

And yet another embodiment would have a secure digital card with the mentioned information attached to a necklace or lanyard.

Although the description above contains many specificities, these should not be construed as limiting the scope of the invention but as merely providing illustrations of some of the preferred embodiments of this invention. For example, the portable storage media might be different colors other than red, and come in many different shapes and sizes with different types of labels on it denoting emergency and personal data information contained.

### SUMMARY

In accordance with the present invention, a portable device containing crucial personal and medical information for use by emergency and medical personnel in an emergency or urgent setting, that is easily accessible by anyone with either a laptop or desktop computer.

### OBJECTS AND ADVANTAGES

Accordingly, some of the obvious objects and advantages are:
(a) a concise personal copy of important personal and medical information;
(b) an easily accessible and editable data storage form;
(c) a method to carry important medical information for people with memory problems;
(d) a very portable and effective carrying means;
(e) an universal format which is read by virtually every computer in existence
(f) highly selective information which is instantly useful for emergency personnel

I claim:

1) A method to transmit important personal and medical information via portable media storage device comprising:
a. non-encrypted personal and medical information;
b. a type of portable information storage media;
c. carrying means;
d. computer
whereby said non-encrypted personal and medical information is stored on said type of portable information storage media;
whereby said type of portable information storage media is placed into said carrying means;
whereby emergency medical personnel can obtain said non-encrypted personal and medical information from said portable information storage media by inserting into said computer, which would enable them to more effectively treat the person carrying said portable information storage media.

2) The method to transmit important personal and medical information of claim 1, wherein said type of portable media is an USB flash drive.

3) The method to transmit important personal and medical information of claim 1, wherein, said carrying means being selected from the group consisting of keychains, necklaces, and lanyards.

4) The method to transmit important personal and medical information of claim 2, wherein, further including the outside of said USB flash drive is labeled with words from the group consisting of: medical, emergency, personal, data, file, files, information.

5) The method to transmit important personal and medical information of claim 2, wherein said USB flash drive has a primary color of substantially red, which is the universal color of emergency medicine.

6) A method to safely return patients with dementia who have wandered off from home and are lost comprising:
a) a type of portable information storage media;
b) a type of carrying device;
c) non-encrypted important personal and medical information;
d) computer
whereby said portable information storage media contains said non-encrypted important personal and medical information, and is being carried by said type of carrying device;
whereby a police officer or other person noticing said patient with dementia carrying said portable information storage media containing said non-encrypted important personal and medical information, being carried by said carrying device, can access said information by inserting said portable information storage media into said computer, obtain the information needed to return said patient with dementia to his or her home.

7. The method to safely return patients with dementia of claim 6, wherein said type of portable information storage media be selected from the group consisting of: secure digital card, mini-secure card, USB flash drive.

8. The method to safely return patients with dementia of claim 6, wherein, said type of carrying device be selected from the group consisting of: keychain, necklace, lanyard.

9. The method to safely return patients with dementia of claim 7, wherein said type of portable information storage media has a primary color of substantially red.

10. The method to safely return patients with dementia of claim 6, wherein said type of portable information storage media is labeled with words from the following group consisting of: medical, emergency, personal, data, file, files, information.

11. A method for children to carry important personal and medical information comprising:
a) a type of portable information storage media;
b) a type of carrying device;
c) non-encrypted important personal and medical information;
whereby said portable information storage media contains said non-encrypted important personal and medical information, and is being carried by said type of carrying device;
whereby a school or relative can transport said children in case of emergency to an emergency facility;
whereby said emergency facility can easily obtain needed information from said portable storage media, so that said children can be treated more effectively and safely.

12. The method for children to carry important personal and medical information of claim 11, wherein said portable storage media be selected from the group consisting of: secure digital card, mini-secure digital card, USB flash drive.

13. The method for children to carry important personal and medical information of claim 11, wherein said carrying device be selected from the group consisting of: keychain, necklace, lanyard.

14. The method for children to carry important personal and medical information of claim 12, wherein said portable storage media has a primary color of substantially red.

15. The method for children to carry important personal and medical information of claim 12, wherein said portable storage media is labeled with words from the group consisting of: emergency, personal, medical, file, files, information.
